(19) United States
(12) Patent Application Publication
(10) Pub. No.: US 2026/0078595 A1
(43) Pub. Date: Mar. 19, 2026

(54) FIBER-REINFORCED POLYMER (FRP) COMPOSITE SWIMMING POOLS AND METHOD OF CONSTRUCTING FRP COMPOSITE SWIMMING POOLS

(71) Applicant: Tom SALTER

(72) Inventor: Tom SALTER, Epping (AU)

(21) Appl. No.: 19/283,281

(22) Filed: Jul. 29, 2025

(30) Foreign Application Priority Data
Sep. 17, 2024 (AU) 2024219814

(51) Int. Cl. E04H 4/00; B29C 70/68; B29K 31/00; B29K 309/08; B29L 31/52; B32B 1/00; B32B 27/30

(52) U.S. Cl. CPC E04H 4/0037; B29C 70/68; B32B 1/00; B32B 27/306; B29K 2031/00; B29K 2309/08; B29L 2031/5254; B32B 2260/023; B32B 2260/046; B32B 2262/101; B32B 2439/02; E04H 2004/0068

(57) ABSTRACT

The present disclosure relates to a swimming pool and to a method of constructing the swimming pool. The swimming pool includes a basin structure, and a framework affixed externally to the basin structure. The basin structure is made of a bottom surface and a plurality of walls extending upwardly, defining an internal cavity for containing water. The basin structure is formed of a Fiber-Reinforced Polymer (FRP) composite. The framework includes a plurality of support assemblies positioned exterior to the basin structure. The plurality of support assemblies includes stiffened elements provided on one or more edges and corners of the basin structure and extending across a top periphery of the basin structure. The framework including the plurality of support assemblies is further affixed to the basin structure by applying a lamination of the FRP composite and a polymeric material over the basin structure and the framework.

### TECHNICAL FIELD

The present disclosure generally relates to the field of reinforced structural systems. In particular, the present disclosure relates to a Fiber-Reinforced Polymer (FRP) composite swimming pool suitable for use in-ground, partly above-ground, or fully above-ground and to a method of constructing the FRP composite swimming pool with enhanced durability, ease of installation, and structural integrity.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may correspond to implementations of the claimed technology.

In recent years, demand for swimming pools has increased in residential, commercial, and recreational settings. Traditionally, the swimming pools are constructed using materials such as concrete, vinyl, metal, or the like. However, construction of the swimming pools from these materials often present significant challenges related to structural integrity, durability, and maintenance.

One of the primary challenges with conventional swimming pools is difficulty in achieving a balance between structural strength and flexibility. For example, concrete swimming pools are prone to cracking and require frequent maintenance, since the same lack the necessary flexibility to accommodate underground shifts, leading to cracks and leaks over time. Vinyl-lined pools, on the other hand, offer some flexibility but at the expense of durability, since vinyl lining deteriorates rapidly owing to exposure to sunlight, chemicals, and physical wear. Further, metal pools, although structurally sound, are susceptible to corrosion, especially in environments with high moisture or salt content.

Additionally, a construction process of the conventional swimming pools is time-consuming and labour-intensive, since the same involves multiple stages, including excavation, reinforcement, and lining or plastering, each of which can introduce delays and increase costs. The complexity of the construction process also makes it difficult to ensure consistent quality of the swimming pools across different installations. Further, variations in workmanship leads to uneven surfaces, leaks, and other structural issues that compromise the longevity and usability of the pool. Moreover, transportation and installation of conventional pool structures pose significant logistical challenges since the swimming pools constructed from heavy materials like concrete or metal require substantial effort and specialized equipment for transport and placement. Further, size and weight of pool components limits the locations where they can be installed, thereby restricting design and customization options available.

Attempts have been made in the past to overcome above challenges associated with the conventional swimming pools. To this end, advanced materials such as Fiber-Reinforced Polymer (FRP) composites are increasingly used as pool construction materials. The FRP composites, such as fiberglass, provide an excellent combination of strength, durability, and flexibility, making them ideal for use in swimming pool construction.

Compared to traditional concrete or vinyl-lined pools, fiberglass pools offer several distinct advantages. The fiberglass pools are renowned for their smooth, non-porous surfaces, which resist algae growth and make cleaning and maintenance considerably easier. Further, the installation process for the fiberglass pools is also typically faster, since the pool shells are prefabricated and can be installed in lesser time compared to the concrete swimming pools.

However, existing fiberglass swimming pools and their construction methods suffer from various issues. One of the primary issues with the existing fiberglass swimming pools is the tendency for structural deformation over time. Further, traditional fiberglass pools often suffer from warping, especially at the edges and corners where stress concentrations are highest. This deformation leads to aesthetic and functional problems, such as uneven pool surfaces and water retention.

Furthermore, in cases where the swimming pools are required to be installed partly above-ground, or fully above-ground, the pool shell requires additional strength. Moreover, transportation and installation of the existing fiberglass swimming pools present challenges, particularly when the pool shells lack sufficient structural integrity. Without adequate reinforcement, the pool shells are susceptible to damage during handling, which results in costly repairs or replacements before the pool is even installed. The effect of inadequate structural support or reinforcement is more pronounced in larger or deeper pools; hence, these pools experience deformation, especially under the weight of water, leading to long-term structural issues.

Another limitation of existing fiberglass pool designs is difficulty in achieving a secure attachment between the pool shell and external support structures. Conventional methods of attaching frameworks or support assemblies to the pool shell often result in weak points that can lead to detachment or damage over time. This issue is exacerbated by environmental factors such as temperature fluctuations and ground movement, which can cause the pool shell to expand or contract, further stressing the attachment points.

Moreover, the existing fiberglass swimming pools are not designed for above ground installations and require a stabilized sand and cement backfill adjacent to the pool shell between excavation and the pool shell. Further, presence of voids/air bubbles in the back fill often cause the pool shell to crack when the pool shell is filled since pool shell is not designed to withstand the water pressure without back fill stabilizer. Additionally, the existing fiberglass swimming pools require concrete reinforced bond beams around the swimming pool to stop the pool shell from moving. Further, owing to flexibility of the pool shell, in scenarios when there are a lot of water around the fibreglass pool when installed, the pool shell moves inwards i.e., away from the backfill, thereby causing the backfill to loosen and fall to a bottom of the shell while the shell is pushed in from the water around the outside. This stops the pool shell from moving back to the original position. Furthermore, in cases where the existing fiberglass swimming pools are to be installed on reactive soils, a high strength sand and cement backfilling and a stronger and wider concrete bond beam are required.

In view of the aforementioned challenges associated with the existing fiberglass swimming pools and their construction methods, there is a need for an improved swimming pool design that is not only durable and aesthetically pleasing but also easier to transport and install.

### SUMMARY

The summary is provided to introduce aspects related to swimming pool design and a method of construction of the swimming pool, and the aspects are further described below in the detailed description. This summary is not intended to identify essential features of the claimed subject matter nor is it intended for use in determining or limiting the scope of the claimed subject matter.

According to a first aspect of the present disclosure, a swimming pool is disclosed. The swimming pool includes a basin structure, and a framework affixed externally to the basin structure. The basin structure is made of a bottom surface and a plurality of walls extending upwardly, defining an internal cavity for containing water. The basin structure is formed of a Fiber-Reinforced Polymer (FRP) composite. The framework includes a plurality of support assemblies positioned exterior to the basin structure. The plurality of support assemblies includes a stiffened element provided on one or more edges and corners of the basin structure and extending across a top periphery of the basin structure. The framework including the plurality of support assemblies is further affixed to the basin structure by applying a lamination of the FRP composite and a polymeric material over the basin structure and the framework.

In one or more embodiments, the FRP composite corresponds to fiberglass.

In one or more embodiments, the plurality of support assemblies further comprises a plurality of vertical members affixed to at least one wall of the plurality of walls, and a plurality of horizontal members affixed to at least a stepped portion provided on the bottom surface of the basin structure.

In one or more embodiments, the plurality of vertical members is formed from one or more sections comprising rectangular portions, U-beams, or I-beams.

In one or more embodiments, the plurality of vertical members comprises at least a partially overlapping section forming a stepped configuration that aligns with horizontal stepped portions provided in the at least one wall of the basin structure.

In one or more embodiments, the overlapping section of the plurality of vertical members has a depth corresponding to a width of the horizontal stepped portions.

In one or more embodiments, the stiffened element comprises one or more structural sections arranged one over the other, and layers of the FRP composite, and optionally the polymeric material and a gelcoat applied over the one or more structural sections.

In one or more embodiments, the stiffened element comprises the one or more structural sections depending on a length of the basin structure and a depth of water contained in the basin structure.

In one or more embodiments, the one or more structural sections corresponds to rectangular hollow sections.

In one or more embodiments, the stiffened element further comprises additional support members including embedded inserts or brackets, ensuring enhanced rigidity and stability of the basin structure.

In one or more embodiments, the stiffened element provided at the one or more edges and corners are designed with interlocking features for secure attachment of additional structural elements including ladders, handrails, or decking.

In one or more embodiments, the polymeric material corresponds to resin material.

In one or more embodiments, the swimming pool further comprises at least one slot provided on at least one pair of opposite walls of the plurality of walls, for lifting the swimming pool.

In one or more embodiments, the swimming pool comprises a plurality of gelcoat layers as an innermost layer, a protective layer formed of the FRP composite, and the polymeric material laminated over the plurality of gelcoat layers to act as a moisture barrier and protect the gelcoat. The FRP composite corresponds to the fiberglass material and the polymeric material corresponds to a vinyl ester resin. The swimming pool further comprises a structural layer of the FRP composite, and the polymeric material applied over the protective layer, and a finishing layer of the FRP composite and the polymeric material applied over the basin structure and the framework.

According to another aspect of the present disclosure, a method of constructing a swimming pool is disclosed. The method comprises applying a plurality of gelcoat layers to a mould for forming the swimming pool in multiple stages. The method further comprises applying a thick structural layer of a Fiber-Reinforced Polymer (FRP) composite and a polymeric material to form a basin structure having a bottom surface and a plurality of walls extending upwardly, defining an internal cavity for containing water. The method comprises affixing a stiffened element to one or more edges and corners of the basin structure and extending across a top periphery of the basin structure and affixing a plurality of vertical members to at least one wall of the plurality of walls. Furthermore, the method comprises laminating a finishing layer of the FRP composite and the polymeric material over the basin structure and a framework affixed externally to the basin structure, and applying a sealing resin over the basin structure to completely encapsulate the basin structure and the framework. The method further comprises allowing the pool structure to cure within the mould for a specified period and extracting the cured pool structure from the mould.

According to another aspect of the present disclosure a swimming pool is disclosed. The swimming pool comprises a basin structure made of a bottom surface and a plurality of walls extending upwardly, defining an internal cavity for containing water, wherein the basin structure is formed of a Fiber-Reinforced Polymer (FRP) composite; a plurality of gelcoat layers as an innermost layer of the basin structure; a protective layer of the fiber-reinforced polymer composite and a polymeric material applied over the plurality of gelcoat layers; and a framework affixed externally to the basin structure, the framework having a plurality of support assemblies positioned exterior to the basin structure, wherein the plurality of support assemblies includes a stiffened element provided on one or more edges and corners of the basin structure and extending across a top periphery of the basin structure, the stiffened elements include one or more structural sections arranged one over the other, and layers of the fiber-reinforced polymer composite, the polymeric material and a gelcoat applied over the one or more structural sections, and wherein the basin structure and the framework having the plurality of support assemblies are subjected to a lamination of the FRP composite and the polymeric material over the basin structure and the framework.

According to another aspect of the present disclosure, a method of constructing a swimming pool is disclosed. The method comprises a applying a plurality of gelcoat layers to a mould for forming the swimming pool in multiple stages; laminating a thin protective layer of a fiber-reinforced polymer composite and a polymeric material over the plurality of gelcoat layers; applying a thick structural layer of the Fiber-Reinforced Polymer (FRP) composite and the polymeric material over the thin protective layer forming a basin structure having a bottom surface and a plurality of walls extending upwardly, defining an internal cavity for containing water; affixing a framework externally to the basin structure, the framework having a plurality of support assemblies positioned exterior to the basin structure, wherein the plurality of support assemblies includes a stiffened element provided on one or more edges and corners of the basin structure and extending across a top periphery of the basin structure, wherein the stiffened elements include one or more structural sections arranged one over the other, and layers of the fiber-reinforced polymer composite, the polymeric material and a gelcoat applied over the one or more structural sections; laminating a finishing layer of the FRP composite and the polymeric material over the basin structure and the framework; applying a sealing resin over the basin structure and the framework to integrate the basin structure and the framework forming a pool structure; allowing the pool structure to cure within the mould for a specified period; and extracting the cured pool structure from the mould.

In one or more embodiments, the method further comprises laminating a thin protective layer of the FRP composite and the polymeric material over the plurality of gelcoat layers, and applying the thick structural layer of the FRP composite and a polymeric material over the thin protective layer.

In one or more embodiments, the affixing the stiffened element to the one or more edges and corners of the basin structure comprises positioning one or more structural sections one over the other, along the edges and corners of the basin structure; and applying layers of the FRP composite and optionally the polymeric material and the gelcoat applied over the one or more structural sections.

In one or more embodiments, the affixing the plurality of vertical members to the at least one wall comprises affixing the plurality of vertical members having at least a partially overlapping section to the at least one wall. The plurality of vertical members forms a stepped configuration aligning with horizontal stepped portions provided on the at least one wall of the basin structure and laminating layers of the fiber-reinforced polymer composite and the polymeric material over the plurality of vertical members.

In one or more embodiments, the method further comprises affixing a plurality of horizontal members to at least a stepped portion of the bottom surface of the basin structure. The plurality of horizontal members is adapted to provide additional structural support and rigidity to the bottom surface of the basin structure.

In one or more embodiments, the FRP composite corresponds to fiberglass and the polymeric material corresponds to a resin material.

In one or more embodiments, the method further comprises forming at least one slot provided on at least one pair of opposite walls of the plurality of walls for lifting the swimming pool after curing.

In one or more embodiments, the basin structure is formed from a combination of layers including a plurality of gelcoat layers as an innermost layer, a protective layer formed of the fiber-reinforced polymer composite and the polymeric material laminated over the plurality of gelcoat layers, a structural layer of the fiber-reinforced polymer composite and the polymeric material applied over the protective layer, and a finishing layer of the fiber-reinforced polymer composite and the polymeric material applied over the basin structure and the framework. The fiber-reinforced polymer composite corresponds to the fiberglass material and the polymeric material corresponds to a vinyl ester resin.

In one or more embodiments, the protective layer has a thickness of approximately 1 mm, the structural layer has a thickness of approximately 6 mm, and the finishing layer has a thickness of approximately 2 mm.

Other aspects and advantages of the present disclosure will become apparent from the following description, taken in conjunction with the accompanying drawings, illustrating by way of example, the principles of the present disclosure.

### BRIEF DESCRIPTION OF DRAWINGS

Non-limiting and non-exhaustive embodiments of the disclosure are described with reference to the following figures, wherein reference numerals refer to like parts throughout the various views unless otherwise specified. The accompanying drawings constitute a part of the description and are used to provide a further understanding of the present disclosure. Such accompanying drawings illustrate the embodiments of the present disclosure used to describe the principles of the present disclosure. The embodiments are illustrated by way of example and not by way of limitation in the figures of the accompanying drawings in which references indicate similar elements. It should be noted that references to “an” or “one” embodiment in this disclosure are not necessarily to the same embodiment, and they mean at least one. In the drawings:

FIG. 1 illustrates a perspective view of a swimming pool in an initial stage of its construction, in accordance with an embodiment of the present disclosure.

FIG. 2 illustrates a perspective view of the swimming pool in a subsequent stage of its construction, in accordance with an embodiment of the present disclosure.

FIG. 3 illustrates a flowchart depicting a construction method of the swimming pool, in accordance with an embodiment of the present disclosure.

FIG. 4 illustrates a top plan view of an example swimming pool, in accordance with an embodiment of the present disclosure.

FIG. 5A illustrates a side view of a swimming pool with a sloping base, in accordance with an embodiment of the present disclosure.

FIG. 5B illustrates a side view of a swimming pool with a levelled base, in accordance with an embodiment of the present disclosure.

FIG. 6 illustrates a front two-dimensional (2D) view of an example swimming pool, in accordance with an embodiment of the present disclosure.

FIG. 7 illustrates a detailed view of vertical members provided on walls of the basin structure, in accordance with an embodiment of the present disclosure.

FIG. 8A through 8C illustrate perspective views of example configurations of stiffened elements, in accordance with different embodiments of the present disclosure.

FIG. 9A through 9C illustrate 2D front views of example configurations of stiffened elements, in accordance with different embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” or “lateral” or “adjacent” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less than” and “greater than”, are intended to encompass the concept of equality. As an example, “less” can mean not only “less” in the strictest mathematical sense, but also, “less than or equal to.”

The present disclosure relates to swimming pools and to a method of constructing the swimming pools. An object of the present disclosure is to provide an improved Fiber-Reinforced Polymer (FRP) composite swimming pool and a method of constructing the FRP composite swimming pool that overcomes structural and performance deficiencies of existing swimming pools, offering enhanced durability, rigidity, and resistance to deformation. Another object of the present disclosure is to provide an FRP composite swimming pool with reinforced structural elements, including a robust framework and reinforced edging (or coping), ensuring the pool retains its shape and structural integrity even when subjected to hydrostatic pressure, handling, or environmental stress. Another object of the present disclosure is to prevent osmotic blistering in FRP composite swimming pools by applying a protective layer of resin and FRP composite immediately behind a gelcoat layer to create a moisture barrier that prevents water penetration and degradation of pool surface. Another object of the present disclosure is to provide an FRP composite swimming pool design that facilitates ease of transportation, installation, and handling, by reinforcing a pool shell with structural elements that prevent damage during lifting and transport, thereby minimizing the risk of cracking or warping before installation. Another object of the present disclosure is to provide an FRP composite swimming pool having a smooth and aesthetically pleasing surface while providing functional advantages such as algae resistance, minimal maintenance, and long-term durability.

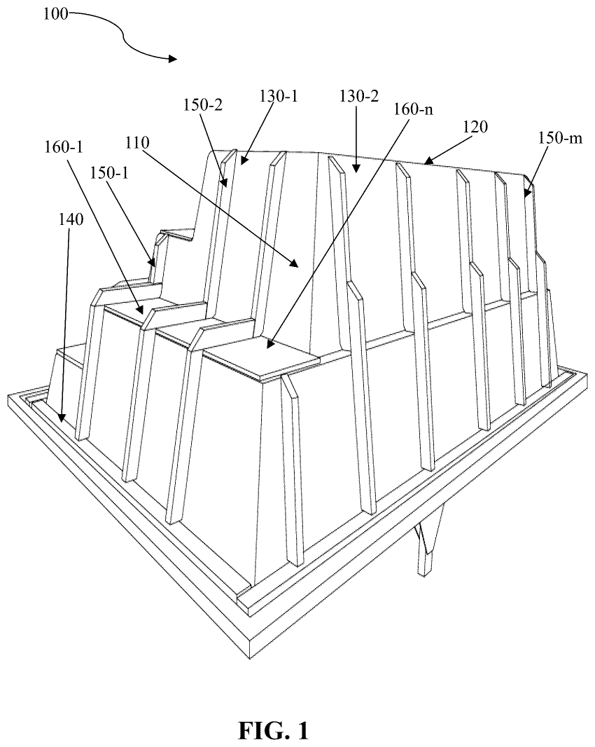

Embodiments of the present disclosure will now be described with reference to FIG. 1 through FIG. 9.

FIG. 1 illustrates a perspective view of a swimming pool 100 in an initial stage of its construction, in accordance with an embodiment of the present disclosure. The swimming pool 100 (in inverted configuration) comprises a basin structure 110 formed of a bottom surface 120. In the context of a swimming pool, the “basin structure” refers to a structural body of the swimming pool where water is held. The basin structure 110 is the main component that defines a shape and depth of the swimming pool and is typically constructed from materials like concrete, fiberglass, Fiber-Reinforced Polymer, or the like. The basin structure 110 is responsible for containing the water and providing the necessary structural integrity to withstand external forces such as weight of the water and soil pressure.

The basin structure 110 includes four walls 130-1, 130-2, 130-3 (not shown in FIGURES) and 130-4 (not shown in FIGURES) (hereinafter may also be collectively referred to as the “walls 130”) extending upwardly from the bottom surface 120, defining an internal cavity for containing water. In an implementation, the basin structure 110 is made of the FRP composite. In another implementation, the FRP composite corresponds to fiberglass. Fiberglass is a composite material made from extremely fine glass fibers, which are woven together to form a flexible fabric. The glass fibers are embedded in a resin, for instance, polyester, vinyl ester, epoxy, or the like, which hardens to create a durable and strong material.

The swimming pool 100 further includes a framework affixed externally to the basin structure 110. The framework includes support assemblies positioned exterior to the basin structure 110. The support assemblies include a stiffened element 140, vertical members 150-1 through 150-m (hereinafter may also be collectively referred to as the “vertical members 150”), horizontal members 160-1 through 160-n (hereinafter may also be collectively referred to as the “horizontal members 160”).

The stiffened element 140 is provided on edges of the basin structure 110 and extends across a top periphery of the basin structure 110. The stiffened element 140 comprises a structural section 140-1. In an alternative embodiment (not shown in FIG. 1), the stiffened element may comprise more than one structural section arranged one over the other, and layers of the FRP composite, the polymeric material and a gelcoat applied over structural sections. In an implementation, an 8 mm layer of the FRP composite, the polymeric material and the gelcoat is applied over the structural sections.

A number of structural sections forming the stiffened element 140 depends on a length of the basin structure and a depth of water contained in the basin structure 110. In an implementation, the structural section correspond to a Rectangular Hollow Section (RHS). In another implementation, the stiffened element 140 may comprise additional support members including embedded inserts or brackets, ensuring enhanced rigidity and stability of the basin structure 110. The stiffened element 140 may be additionally designed with interlocking features for secure attachment of additional structural elements including ladders, handrails, or decking. In an implementation, the polymeric material corresponds to resin material.

Referring to FIG. 1, the vertical members 150 comprise partially overlapping sections forming a stepped configuration that aligns with horizontal stepped portions provided in the walls 130 of the basin structure 110. In an implementation, the overlapping section of the vertical members 150 has a depth corresponding to a width of the horizontal stepped portions. In another implementation, the vertical members may be formed of timber, steel, shaped cardboard and the like. The vertical members 150 are affixed externally to the basin structure 110 during the swimming pool construction process to maintain desired shape and alignment of the walls 130. The vertical members 150 are strategically placed along the walls 130 of the basin structure 110 to prevent deformation and to ensure that the walls 130 are held in a precise orientation during curing of the FRP composite material. In an implementation, the vertical members 150 are formed from sections comprising rectangular portions, U-beams, I-beams, or the like.

The horizontal members 160 are affixed to stepped portions provided on the bottom surface 120 of the basin structure 110. The horizontal members 160 provide additional strength to the bottom surface 120 to withstand the weight of water and ground pressure.

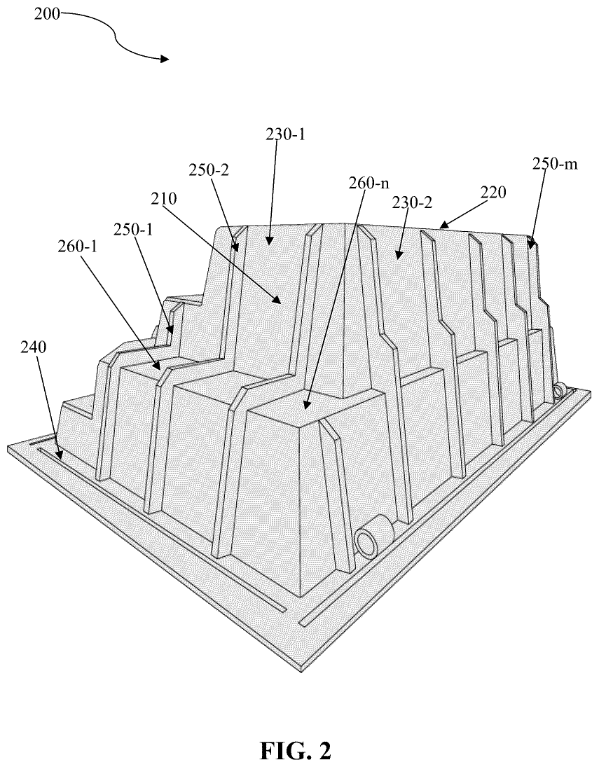

FIG. 2 illustrates a perspective view of a swimming pool 200 in a subsequent stage of its construction, in accordance with an embodiment of the present disclosure.

Referring to FIG. 2, the swimming pool 200 (in inverted configuration) includes a basin structure 210 formed of a bottom surface 220. The basin structure 210 includes four walls 230-1, 230-2, 230-3 (not shown in FIGURES) and 230-4 (not shown in FIGURES) (hereinafter may also be collectively referred to as the “walls 230”) extending upwardly from the bottom surface 220, defining an internal cavity for containing water. The swimming pool 200 further includes the framework including support assemblies positioned exterior to the basin structure 210. The support assemblies include a stiffened element 240, vertical members 250-1 through 250-m (hereinafter may also be collectively referred to as the “vertical members 250”), horizontal members 260-1 through 260-n (hereinafter may also be collectively referred to as the “horizontal members 260”).

The swimming pool 200 may further include slots 270 provided on a pair of opposite walls for lifting the swimming pool.

A layer of the FRP composite material, comprising fiberglass, and a polymeric material is laminated over the exterior of the basin structure 210 and the framework integrating the basin structure 210 and the framework as a single unit. This layer provides structural reinforcement and enhances the durability of the pool, ensuring resistance to environmental stressors and prolonged use.

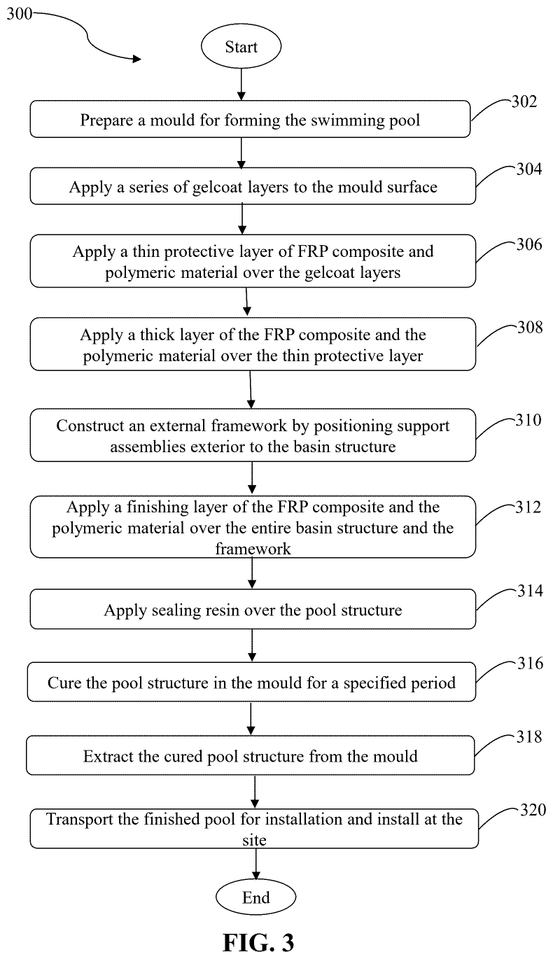

FIG. 3 illustrates a flowchart depicting a construction method 300 of the swimming pool, in accordance with an embodiment of the present disclosure. The construction method 300 (hereinafter may also be referred to as the “method 300”) comprises a series of steps 302 through 320. The method 300 begins at block 302.

At block 302, a mould for forming the swimming pool is prepared, ensuring that the mould is true and level, including the bottom surface, walls, and top rim, to create a precise replica of the desired pool shape.

At block 304, a series of gelcoat layers is applied to the pool mould. In an implementation, the gelcoat layers comprise a dyed polymer resin. The gelcoat layers are applied in multiple stages to achieve a smooth, durable finish that defines an interior colour and surface of the pool. In an implementation, the gelcoat layers have a minimum thickness of approximately 0.35 mm.

At block 306, a thin protective layer of the FRP composite and the polymeric material, such as vinyl ester resin, is applied over the gelcoat layers. This protective layer acts as a moisture barrier to protect against osmotic blistering and ensures the longevity of the pool shell. In an implementation, the protective layer has a thickness of approximately 1 mm.

At block 308, a thick structural layer of the FRP composite and the polymeric material is applied over the thin protective layer, forming the basin structure. In an implementation, the structural layer has a thickness of approximately 6 mm.

At block 310, an external framework is constructed by positioning support assemblies exterior to the basin structure. The framework is affixed to the basin structure and includes the vertical members and the horizontal members that are strategically arranged along the walls and the bottom surface of the basin structure. The framework includes the stiffened element provided on the edges of the basin structure, extending across the top periphery. The stiffened element may include a single RHS or more than one RHS arranged one over the other, and layers of the FRP composite, the polymeric material, and the gelcoat are applied over the one or more RHSs to ensure that the periphery of the basin structure is reinforced. In an embodiment, the RHS may be formed of a material such as steel, or the like.

In an implementation, additional support members such as embedded inserts or brackets may be added to the stiffened element to provide enhanced rigidity and stability to the basin structure. In another implementation, the stiffened element may include interlocking features to securely attach additional structural elements such as ladders, handrails, or decking.

At block 312, a finishing (final) layer of the FRP composite and the polymeric material is applied over the entire basin structure and the framework, encapsulating all structural components to create a unified, structurally robust pool structure. In an implementation, the finishing layer has a thickness of approximately 2 mm.

At block 314, a sealing resin layer is applied over the pool structure to ensure complete encapsulation of all underlying materials, providing a final smooth and protective finish. In an implementation, the sealing resin layer has a minimum thickness of 0.2 mm.

At block 316, the pool structure is allowed to cure within the mould for a specified period, ensuring that the materials are properly set and achieve the desired structural integrity and finish. In an implementation, the spec

At block 318, the cured pool structure is extracted from the mould, ensuring it retains the precise shape and structural features designed during the mould preparation phase.

At block 320, the finished pool structure is transported for installation, utilizing the slots provided on the opposite walls of the basin structure for lifting. The slots are designed to facilitate safe and efficient handling of the pool structure during transportation and installation.

The pool structure is then installed at the site. This includes setting the pool structure in place, pumping in adhesive slurry in an annulus between the pool and the ground, connecting necessary plumbing, and ensuring that the pool is level and secure. The pool is then filled with water and tested for leaks and performance.

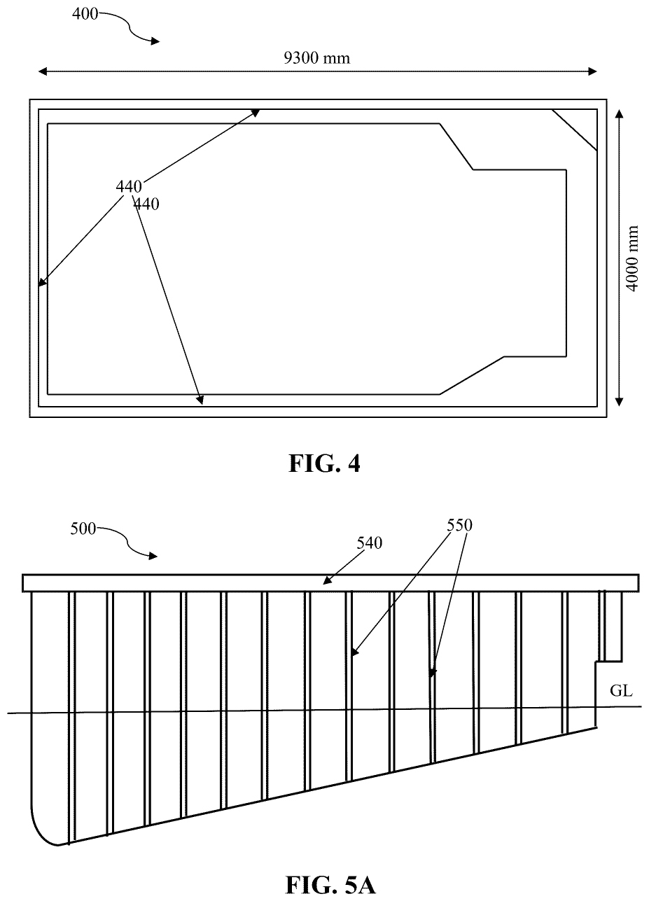

FIG. 4 illustrates a top plan view of an example swimming pool 400, in accordance with an embodiment of the present disclosure. The example swimming pool 400 (hereinafter may also be referred to as “the swimming pool 400”) has a maximum length of 9300 mm and a maximum width of 4000 mm. The swimming pool 400 further includes a stiffened element 440 (or coping) extending around the entire periphery of the pool, providing continuous structural reinforcement along all sides. The stiffened element 440 helps to prevent deformation during installation and ensure that the edges of the pool maintain structural integrity when installed in-ground or above ground. The swimming pool 400 has a rectangular design and is intended to support both level and sloped base configurations. The stiffened element 440 provides additional strength and rigidity to the swimming pool 400 and help in particularly constructing durable and lightweight above-ground pool.

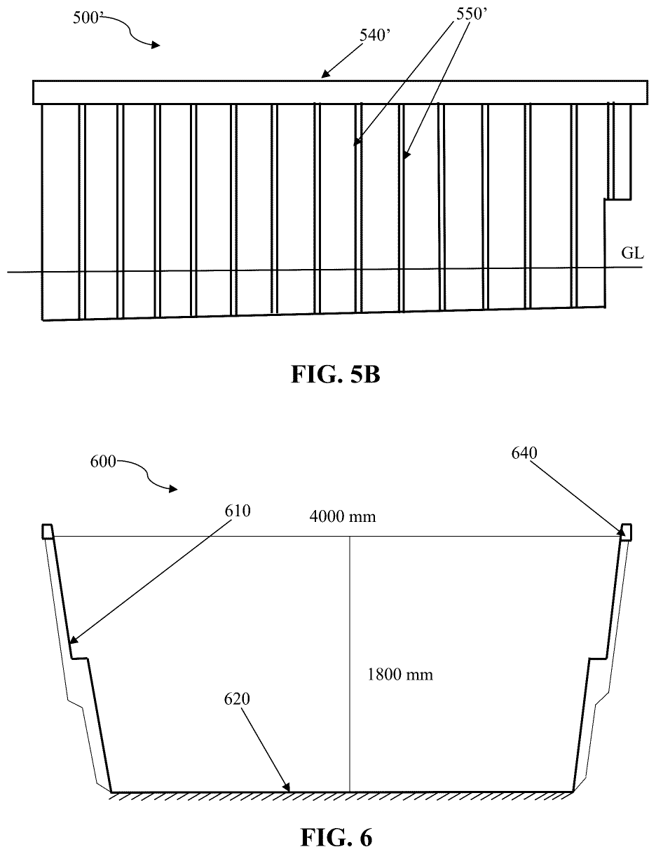

FIG. 5A illustrates a side view of a swimming pool 500 with a sloping base, in accordance with an embodiment of the present disclosure. The swimming pool 500 includes a stiffened element 540 (or stiffened coping) at top of the pool walls and vertical members 550 (also referred to as wall stiffeners). The vertical members 550 are provided at regular intervals along the length of the pool to reinforce the walls. In an implementation, the vertical members 550 are provided at intervals of 500 mm along the length of the swimming pool 500. The pool water depth varies from 1200 mm at the shallow end to 1800 mm at the deep end, making it suitable for a range of user preferences. The stiffened coping 540 shown at the top of the pool walls, provides additional rigidity to the swimming pool 500.

FIG. 5B illustrates a side view of a swimming pool 500′ with a levelled base, in accordance with an embodiment of the present disclosure. The swimming pool 500′ includes a stiffened element 540′ (or stiffened coping) at top of the pool walls and vertical members 550′ (also referred to as wall stiffeners). The vertical members 550′ are provided at regular intervals along an entire length of the pool to reinforce the walls. In an implementation, the vertical members 550′ are provided at intervals of 500 mm along the length of the swimming pool 500′. The pool water depth is 1250 mm, maintained uniformly across the length of the swimming pool 500′. The stiffened coping 540′ shown at the top of the pool walls provides additional rigidity to the swimming pool 500, ensuring the pool walls do not flex or warp during installation or usage.

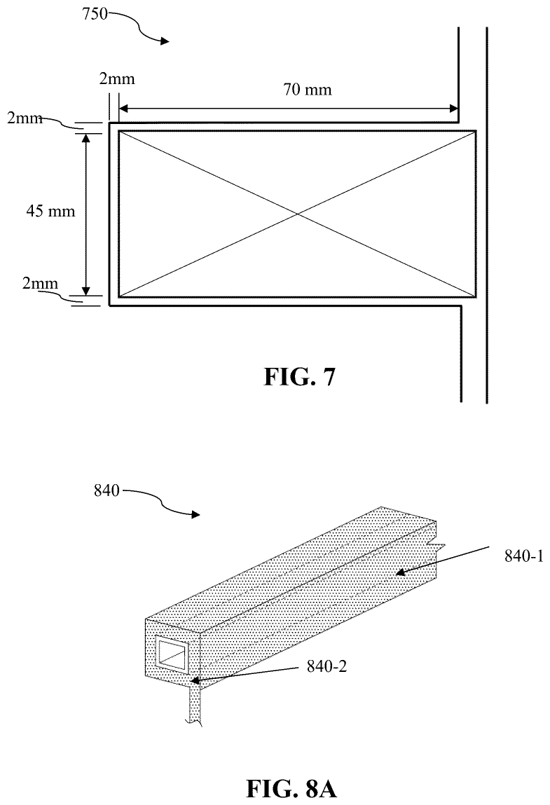

FIG. 6 illustrates a front two-dimensional (2D) view of an example swimming pool 600, in accordance with an embodiment of the present disclosure. The example swimming pool 600 (may also be referred to as the “swimming pool 600”) is shown in its installed orientation with various structural dimensions and components. The swimming pool 600 includes a stiffened element 640 (or stiffened coping 640) for providing additional strength to the swimming pool 640.

In an implementation as shown in FIG. 6, the swimming pool 600 has a maximum width of 4000 mm at a top portion, measured from edge to edge of a rim portion of the swimming pool. In an implementation, a depth of the water level in the swimming pool 600 is 1800 mm. The swimming pool 600 includes an outer shell of the basin structure 610 is constructed of an 8 mm thick FRP composite material for instance, fiberglass. This shell forms a primary structural component of the swimming pool 600 and is adapted for containing the water and providing overall stability.

Referring to FIG. 6, a base portion i.e., a bottom surface 620 of the basin structure 610 is designed to be fully supported on firm, natural ground. In an implementation, the ground has a minimum safe load bearing capacity of 100 kPa. This ensures that the pool structure remains stable and secure once installed.

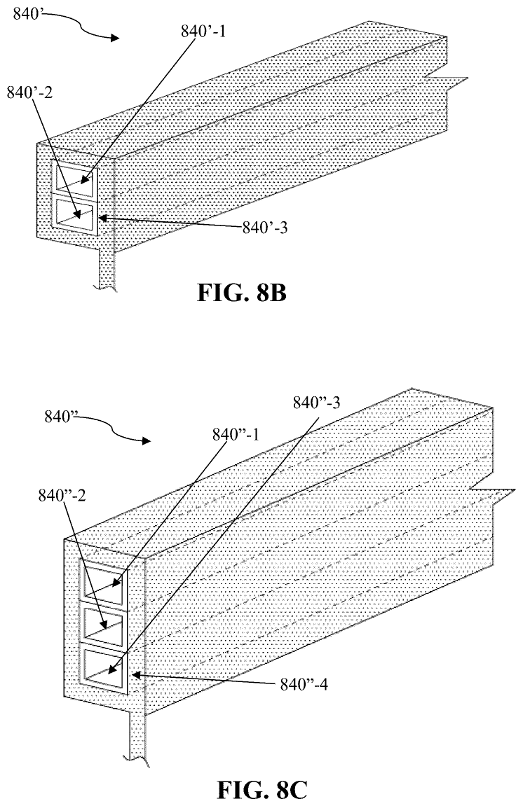

FIG. 7 illustrates a detailed view of vertical members 750 provided on walls of the basin structure, in accordance with an embodiment of the present disclosure. The vertical members 750 (or wall stiffeners) are integrated with the walls of the swimming pool to provide structural support and resist forces exerted by the water inside the swimming pool as well as external pressure exerted by ground/soil.

The vertical members 750 are positioned vertically, extending from the bottom to the top of the walls of the swimming pool. The vertical members 750 are spaced at regular intervals along the length of the walls to uniformly distribute load and reinforce the walls against potential buckling or warping. In an implementation, the vertical members 750 are provided at an interval of 500 mm on the walls of the swimming pool. The vertical members 750 serve as primary structural elements designed to maintain the shape and stability of the pool wall.

In an example implementation, as shown in FIG. 7, a width of the vertical members 750 along a longitudinal direction of the walls is 45 mm and a depth of the vertical members 750 along lateral direction is 70 mm. A layer of FRP composite material for instance, fiberglass is applied over the vertical members having a thickness of 2 mm.

The walls of the swimming pool feature a layered construction, with outer and inner fiberglass layers encapsulating the vertical members 750.

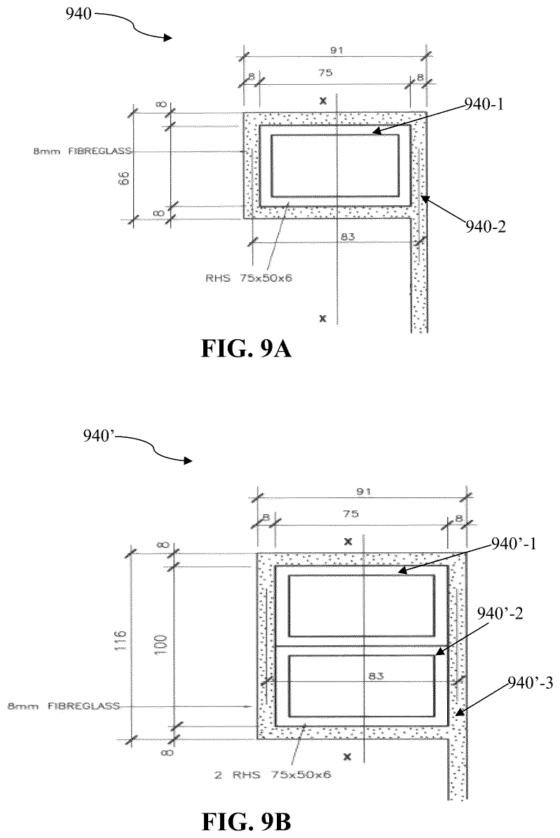

FIG. 8A through 8C illustrate perspective views of example configurations of stiffened elements 840, 840′, 840″, in accordance with different embodiments of the present disclosure.

Referring to FIG. 8A, the stiffened element 840 includes a Rectangular Hollow Section (RHS) 840-1 integrated into the periphery of the walls of the basin structure to enhance its rigidity and resistance to deformation. The RHS 840-1 is encapsulated between the FRP composite layers for instance, fiberglass layers 840-2, ensuring that the RHS 840-1 is fully integrated into the wall's composite structure. In an implementation, the fiberglass layers 840-2, which are 8 mm thick, are applied both on the inside and outside of the pool wall, providing a smooth finish and helping to distribute the loads evenly across the structure. The bonding of the fiberglass to the RHS 840-1 ensures a strong connection between different materials, enhancing overall performance of the pool wall. This configuration of the stiffened element is suitable for a swimming pool with an approximate length of 6 m, depth of water in the swimming pool approximately 1.25 m over the length of the swimming pool and a width of stiffened elements (coping) at pool ends is approximately 4 m.

Referring to FIG. 8B, the stiffened element 840′ include two Rectangular Hollow Sections (RHSs) 840′-1 and 840′-2 arranged one over the other and integrated into the periphery of the walls of the basin structure.

The RHS 840′-1 and the RHS 840′-2 measuring 75×50×6 mm, are placed strategically to counteract bending forces and ensure the structural stability of the wall. In an implementation, fiberglass layers 840′-3, which are 8 mm thick, are applied both on the inside and outside of the pool wall. The upper RHS i.e., the RHS 840′-1 is positioned near the top of the pool wall, where stresses from water pressure and ground forces are typically highest. The lower RHS i.e., the RHS 840′-2 is located closer to the middle or bottom of the wall, providing additional reinforcement in areas subjected to high bending moments. This configuration of the stiffened element is suitable for a swimming pool with an approximate length of 6.1 m to 7.5 m, and the depth of water in the swimming pool approximately 1.25 m to 1.8 m over the length of the swimming pool.

Referring to FIG. 8C, the stiffened element 840″ include three Rectangular Hollow Sections (RHSs) 840″-1 through 840″-3 arranged one over the other and integrated into the periphery of the walls of the basin structure. In an implementation, fiberglass layers 840″-4, which are 8 mm thick, are applied both on the inside and outside of the pool wall. The RHS 840″-1, the RHS 840″-2 and the RHS 840″-3, are placed strategically to counteract bending forces and ensure the structural stability of the wall. This configuration of the stiffened element is suitable for a swimming pool with an approximate length of 7.6 m to 9.3 m, and the depth of water in the swimming pool approximately 1.25 m to 1.8 m over the length of the swimming pool.

As disclosed in the example configuration above, a stiffening element is formed by stacking two or more stiffened elements, each possessing a rectangular or square cross-section. The bars are arranged one on top of the other, creating a composite bar with an aggregated rectangular or square cross-section. With this arrangement, the bars are securely bonded or fastened to ensure the consolidated bar operates as a single structural unit. The consolidated bar design increases the overall strength and rigidity of the structure. By stacking multiple bars, the cross-sectional area is significantly increased, resulting in enhanced load-bearing capacity and improved resistance to bending, deformation, or failure under stress. Additionally, the secure bonding or fastening of the individual bars ensures uniform load distribution, minimizing localized stress points and maximizing durability, and thereby facilitate achieving strong pool walls.

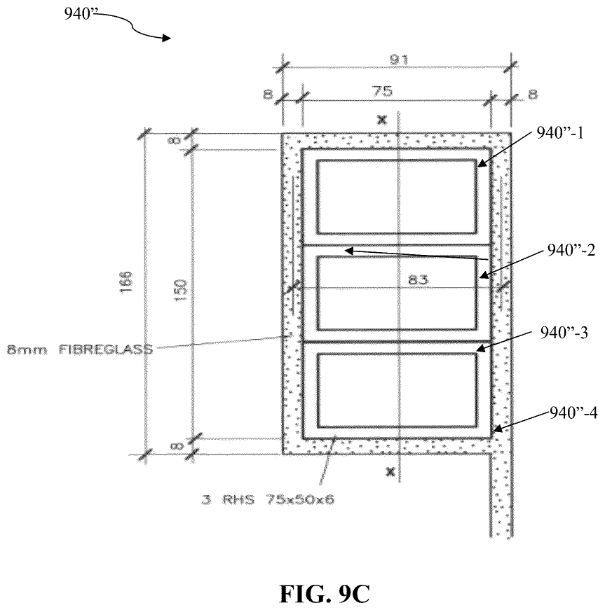

FIG. 9A through 9C illustrate 2D front views of example configurations of stiffened elements 940, 940′, 940″, in accordance with different embodiments of the present disclosure.

Referring to FIG. 9A, the stiffened element 940 include a RHS 940-1 having a dimension of 75×50×6 mm. This configuration of the stiffened element 940 is suitable for a swimming pool with an approximate length of 6 m, the maximum depth of water in the swimming pool being approximately 1.25 m over the length of the swimming pool and a width of stiffened elements (coping) at pool ends being approximately 4 m.

Referring to FIG. 9B, the stiffened element 940′ include two RHSs 940′-1 and 940′-2 arranged one over the other and integrated into the periphery of the walls of the basin structure. The RHS 940′-1 and the RHS 940′-2 measuring 75×50×6 mm, are placed strategically to counteract bending forces and ensure the structural stability of the wall. This configuration of the stiffened element is suitable for a swimming pool with an approximate length of 6.1 m to 7.5 m, and the depth of water in the swimming pool approximately 1.25 m to 1.8 m over the length of the swimming pool. In an implementation, fiberglass layers 940′-3, which are 8 mm thick, are applied both on the inside and outside of the pool wall.

Referring to FIG. 9C, the stiffened element 940″ include three RHSs 940″-1 through 940″-3 arranged one over the other and integrated into the periphery of the walls of the basin structure. In an implementation, fiberglass layers 940″-4, which are 8 mm thick, are applied both on the inside and outside of the pool wall. The RHS 940″-1, the RHS 940″-2 and the RHS 940″-3 measure 75×50×6 mm. This configuration of the stiffened element is suitable for a swimming pool with an approximate length of 7.6 m to 9.3 m, and the depth of water in the swimming pool approximately 1.25 m to 1.8 m over the length of the swimming pool.

Load Calculation for the stiffened elements in each of the embodiments in FIG. 9A to 9C.

### Referring to FIG. 9A:

$$Pool end \times 4200 mm wide$$

$$Water depth = 1.8 m$$

Total pressure from water on wall=1.8×10 kPa×1.8/2=16.2 kN/m length of wall located 0.6 m from base.

$$Lateral Load at coping = 16.2 / 3 = 5.4 kN / m$$

$$For 4.2 m long wall , BM = 5.4 \times 4. {2}^{2} / 8 = 11.9 kNm$$

For one RHS 75×50×6 mm with 8 mm fibreglass, BM capacity=13 kNm.
For a 6000 mm long swimming pool with maximum water depth=1.25 m.
Total pressure from water on wall=1.25×10 kPa×1.25/2=7.81 kN/m length of wall located 0.42 m from base.

$$Lateral Load at coping = 7.81 / 3 = 2.6 kN / m$$

$$For 6. mm long shell , BM = 2.6 \times 67 / 8 = 11.7 kNm$$

One RHS 75×50×6 with 8 mm fibre glass used, similar at ends.

Referring to FIG. 9B, for a 7500 mm long pool shell and water depth 1200 mm to 1800 mm.

Average water depth=1.5 m
Total pressure from water on wall=1.5×10 kPa×1.5/2=11.25 kN/m length of wall located 0.5 m from base.

$$Lateral Load at coping = 11.25 / 3 = 3.75 kN / m$$

$$For a 7.5 m long shell , BM = 3.75 \times 7.57 / 8 = 26.36 kNm$$

Capacity of 91×116 mm coping with 8 mm fibreglass over 2 RHS 75×50×6 mm

$${I}_{xx} = 2 \times 116 \times 8 \times 41. {5}^{2} + 7 {5}^{3} \times 8 \times 2 / 12 = 3.2 + 0.56 = 3 \text{.76} \times {10}^{6} {mm}^{4}$$

$${Z}_{xx} = 3 \text{.76} \times {10}^{6} / 45.5 = 8 2.6 \times {10}^{3} {mm}^{3}$$

$$For 2 R H S 75 \times 50 \times 6 mm , {Z}_{xx} = 2 \times 21. 3 = 4 2.6 \times {10}^{3} {mm}^{3}$$

$$Total {Z}_{xx} = 12 5.2 \times {10}^{3} {mm}^{3}$$

$$For {f}_{b} = 0.6 \times 350 = 210 MPa .$$

$$Maximum BM capacity of coping = 125.2 \times 210 / 1000 = 26.29 kNm .$$

Taking into account that some stiffness is provided by the 75 mm step halfway up the wall this is considered acceptable.

Referring to FIG. 9C, for a 9300 mm×4200 mm pool shell and water depth 1200 mm to 1800 mm.

Average water depth=1.5 m
Total pressure from water on wall=1.5×10 kPa×1.5/2=11.25 KN/m length of wall located 0.5 m from base.

$$Lateral Load at coping = 11.25 / 3 = 3.75 kKN / m$$

$$For a 9.3 m long shell BM = 3.75 \times 9.32 / 8 = 40.54 kNm$$

Capacity of 91×166 mm coping with 8 mm fibreglass over 3 RHS of 75×50×6 mm

$${I}_{xx} = 2 \times 166 \times 8 \times 41. {5}^{2} + 7 {5}^{3} \times 8 \times 2 / 12 = 4.57 + 0.56 = 5 \text{.13} \times {10}^{6} {mm}^{4}$$

$${Z}_{xx} = 5 \text{.13} \times {10}^{6} / 45.5 = 11 2.7 \times {10}^{3} {mm}^{3}$$

$$For 3 R H S of 75 \times 50 \times 6 mm , {Z}_{xx} = 3 \times 21. 3 = 63 \text{.90} \times {10}^{3} {mm}^{3}$$

$$Total {Z}_{xx} = 176.6 \times {10}^{3} {mm}^{3}$$

$$For {f}_{b} = 0.6 \times 350 = 210 MPa$$

$$Maximum BM capacity of coping = 176.6 \times 210 / 1000 = 37.09 kNm$$

Taking into account that some stiffness is provided by the 75 mm step halfway up the wall this is considered acceptable.

In one or more embodiments described above, the RHS may be formed of a material such as steel. The use of RHS (Rectangular Hollow Section) steel in the reinforced fiberglass swimming pool structure offers numerous advantages, particularly in terms of structural strength and ease of assembly. The over-the-top arrangement of the one or more RHS sections provides enhanced support to the pool shell, improving its overall rigidity and resistance to deformation, even under varying load conditions. This method ensures that the pool can withstand both above-ground and partly above-ground installations while maintaining its integrity over time. The steel RHS sections, being robust yet relatively lightweight, help to reduce material costs, and their modularity allows for a more efficient stacking process, leading to reduced transportation and storage costs. This design offers a practical solution for building low-cost pools with high structural integrity.

In addition to its structural benefits, the swimming pool design as in the present disclosure boasts significant advantages in terms of lightweight construction and transportability. The FRP composite used in the pool shell ensures that the overall weight is kept low, making it easy to handle and install. This is particularly beneficial for above-ground installations, where the pool can be placed with minimal excavation or ground preparation. Furthermore, the customizable nature of the pool design allows for a variety of shapes and sizes to be produced, catering to different customer needs. The over-the-top arrangement of multiple RHS sections further adds flexibility, enabling the construction of pools that are not only affordable but also stackable for efficient transport and storage, making this a cost-effective and scalable solution for residential and commercial installations alike.

Further, the uniform design of the RHS sections allows for efficient stacking, which significantly reduces the space required for storage and transportation. This feature is particularly advantageous for manufacturers and installers, as it minimizes logistics costs by enabling more sections to be transported in a single shipment. The modular nature of the RHS sections also simplifies on-site assembly, ensuring that the pool's structural components can be quickly and accurately arranged, reducing installation time.

In addition to logistical benefits, the stackability of the RHS sections contributes to the overall cost-effectiveness of the pool construction. By allowing RHS steel members to be stacked and transported efficiently, fewer trips and less handling are required, translating into lower labour and fuel costs. This design feature also ensures that the pool components can be easily stored in warehouses or on-site without taking up excessive space, making it an ideal solution for large-scale production and distribution. Overall, the stackability of the RHS sections enhances the flexibility, efficiency, and affordability of building both above-ground and partly above-ground pools, offering a practical advantage for the pool industry.

Now, referring to the technical abilities and advantageous effect of the present disclosure, advantages that may be provided by one or more embodiments of the present disclosure may include providing a swimming pool that is strong enough to be installed without need of any backfilling or concrete reinforced beams to support the pool shell. A further potential advantage of the one or more embodiments disclosed herein may include, but not limited thereto, providing a swimming pool that does not require to be installed on a concrete base or any stabilizing steel bars. Another noteworthy advantage of the present disclosure may include providing a swimming pool with reduced installation cost since no back fill or reinforced bond beams are required. Yet another advantage of the one or more embodiments may include fastening the swimming pool installation process and that too with less manpower owing to ease of installation, thereby eliminating need of specialized licensed pool installers. Further, owing to provision of the vertical members (such as steel reinforced structures) on the walls and the horizontal members under the floor area, the swimming pool design is suitable for a wide range of models and size of the pool shell. Another potential advantage of the one or more embodiments includes reducing weight of the swimming pool, for example approximating 1500 kg for a 6 m pool shell, thereby eliminating the need of heavy cranes and reduced associated costs compared to a precast concrete plunge. Another noteworthy advantage of the one or more embodiments of the present disclosure may include providing a steel reinforced fiberglass swimming pool that it is suitable for installation in reactive soils without extra reinforcement.

A person skilled in the art will appreciate that alternative components can be utilized in the described embodiments. However, other embodiments could be implemented without utilizing one or more of these mechanisms.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

What is claimed is:

1. A swimming pool comprising:
a basin structure made of a bottom surface and a plurality of walls extending upwardly, defining an internal cavity for containing water, wherein the basin structure is formed of a Fiber-Reinforced Polymer (FRP) composite;
a plurality of gelcoat layers as an innermost layer of the basin structure;
a protective layer of the fiber-reinforced polymer composite and a polymeric material applied over the plurality of gelcoat layers; and a framework affixed externally to the basin structure, the framework having a plurality of support assemblies positioned exterior to the basin structure,
wherein the plurality of support assemblies includes a stiffened element provided on one or more edges and corners of the basin structure and extending across a top periphery of the basin structure, the stiffened elements include
one or more structural sections arranged one over the other, and
layers of the fiber-reinforced polymer composite, the polymeric material and a gelcoat applied over the one or more structural sections, and
wherein the basin structure and the framework having the plurality of support assemblies are subjected to a lamination of the FRP composite and the polymeric material over the basin structure and the framework.

2. The swimming pool of claim 1, wherein the FRP composite corresponds to fiberglass.

3. The swimming pool of claim 1, wherein the plurality of support assemblies further comprises:
a plurality of vertical members affixed to at least one wall of the plurality of walls; and
a plurality of horizontal members affixed to at least a stepped portion provided on the bottom surface of the basin structure.

4. The swimming pool of claim 3, wherein the plurality of vertical members is formed from one or more sections comprising rectangular portions, U-beams, or I-beams.

5. The swimming pool of claim 4, wherein the plurality of vertical members comprises at least a partially overlapping section forming a stepped configuration that aligns with horizontal stepped portions provided in the at least one wall of the basin structure.

6. The swimming pool of claim 1, wherein the stiffened element comprises the one or more structural sections depending on a length of the basin structure and a depth of water contained in the basin structure.

7. The swimming pool of claim 6, wherein the one or more structural sections correspond to rectangular hollow sections.

8. The swimming pool of claim 6, wherein the stiffened element further comprises additional support members including embedded inserts or brackets, ensuring enhanced rigidity and stability of the basin structure.

9. The swimming pool of claim 1, wherein the stiffened element provided at the one or more edges and corners are designed with interlocking features for secure attachment of additional structural elements including ladders, handrails, or decking.

10. The swimming pool of claim 1, further comprising at least one slot provided on at least one pair of opposite walls of the plurality of walls, for lifting the swimming pool.

11. The swimming pool of claim 1, comprising:
a structural layer of the FRP composite and the polymeric material applied over the protective layer; and
a finishing layer of the FRP composite and the polymeric material applied over the basin structure and the framework, wherein the FRP composite corresponds to the fiberglass and the polymeric material corresponds to a vinyl ester resin.

12. A method of constructing a swimming pool, the method comprising:
applying a plurality of gelcoat layers to a mould for forming the swimming pool in multiple stages;
laminating a thin protective layer of a fiber-reinforced polymer composite and a polymeric material over the plurality of gelcoat layers;
applying a thick structural layer of the Fiber-Reinforced Polymer (FRP) composite and the polymeric material over the thin protective layer forming a basin structure having a bottom surface and a plurality of walls extending upwardly, defining an internal cavity for containing water;
affixing a framework externally to the basin structure, the framework having a plurality of support assemblies positioned exterior to the basin structure, wherein the plurality of support assemblies includes a stiffened element provided on one or more edges and corners of the basin structure and extending across a top periphery of the basin structure, wherein the stiffened elements include
one or more structural sections arranged one over the other, and
layers of the fiber-reinforced polymer composite, the polymeric material and a gelcoat applied over the one or more structural sections;
laminating a finishing layer of the FRP composite and the polymeric material over the basin structure and the framework;
applying a sealing resin over the basin structure and the framework to integrate the basin structure and the framework forming a pool structure;
allowing the pool structure to cure within the mould for a specified period; and
extracting the cured pool structure from the mould.

13. The method of claim 12, further comprising:
affixing a plurality of vertical members having at least a partially overlapping section to at least one wall of the basin structure, wherein the plurality of vertical members forms a stepped configuration aligning with horizontal stepped portions provided on the at least one wall of the basin structure.

14. The method of claim 12, further comprising affixing a plurality of horizontal members to at least a stepped portion of the bottom surface of the basin structure, wherein the plurality of horizontal members is adapted to provide additional structural support and rigidity to the bottom surface of the basin structure.

15. The method of claim 12, further comprising forming at least one slot provided on at least one pair of opposite walls of the plurality of walls for lifting the swimming pool after curing.

16. The method of claim 12, wherein the basin structure is formed from a combination of layers including:
a plurality of gelcoat layers as an innermost layer;
a protective layer formed of the FRP composite and the polymeric material laminated over the plurality of gelcoat layers;
a structural layer of the FRP composite and the polymeric material applied over the thin protective layer; and
a finishing layer of the FRP composite and the polymeric material applied over the basin structure and the framework, wherein the FRP composite corresponds to the fiberglass and the polymeric material corresponds to a vinyl ester resin.

17. The method of claim 16, wherein:
the protective layer has a thickness of approximately 1 mm;
the structural layer has a thickness of approximately 6 mm; and
the finishing layer has a thickness of approximately 2 mm.
